(19) United States
(12) Patent Application Publication
(10) Pub. No.: US 2016/0087661 A1
(43) Pub. Date: Mar. 24, 2016

(54) Radio Receiver

(71) Applicant: Alpine Electronics, Inc., Tokyo (JP)

(72) Inventor: Koichi Narita, Iwaki-city (JP)

(21) Appl. No.: 14/859,524

(22) Filed: Sep. 21, 2015

(30) Foreign Application Priority Data
Sep. 24, 2014 (JP) 2014-194514

(51) Int. Cl. H04B 1/10; H04L 27/14

(52) U.S. Cl. CPC H04B 1/1027; H04L 27/14

(57) ABSTRACT

An AM/FM radio receiver includes an AM/FM demodulation circuit that is configured to demodulate a signal that is received; a mute circuit that is configured to perform, on the signal demodulated by the demodulation unit, a mute process with a characteristic corresponding to an electric field strength of the signal that is received; a volume balance optimizing circuit configured to control a volume level of the signal after the mute process to be constant when the volume level of the signal is within a predetermined range; and a low-input attenuation circuit configured to receive an input signal of which the volume level has been controlled by the volume balance optimizing circuit and to attenuate the input signal when the volume level is lower than a predetermined level.

### RELATED APPLICATIONS

The present application claims priority to Japanese Patent Application Serial Number 2014-194514, filed Sep. 24, 2014, the entirety of which is hereby incorporated by reference.

### BACKGROUND OF THE INVENTION

1. Field of the Invention

The present disclosure relates to a radio receiver that receives AM or FM broadcasts.

2. Description of the Related Art

There is conventionally known an FM receiver in which, as the strength of a received electric field decreases, the level of an output signal including noise (AF) is reduced by reducing the amplification factor of a preamplifier. Such a preamplifier amplifies a demodulation signal output from a demodulator on the basis of an S meter voltage which corresponds to the level of an intermediate frequency signal (see, for example, Japanese Unexamined Patent Application Publication No. 8-18468). In such an FM receiver, the S/N ratio of a low-strength electric field can be improved.

In addition, there is conventionally known an AM/FM radio in which a volume balance optimizing process is performed to control a demodulated audio signal to be constant regardless of an input level thereof. The volume balance optimizing process makes it possible to output sound at an appropriate volume for a listener, even when the received AM/FM broadcast signal includes low-volume sound.

In a case where the volume balance optimizing process and the FM receiver disclosed in Japanese Unexamined Patent Application Publication No. 8-18468 are combined, there has been a problem in that noise generated by frequencies between adjacent channels (interchannel noise) is increased, which degrades the S/N ratio of a normal-strength electric field.

### SUMMARY OF THE INVENTION

An object of the present invention is to provide a radio receiver in which an audio signal after demodulation is controlled to be constant regardless of the input level thereof and that can reduce interchannel noise and improve the S/N ratio of a normal-strength electric field.

In some implementations, a radio receiver may include a demodulation unit configured to demodulate a signal that is received; a mute unit configured to perform, on the signal demodulated by the demodulation unit, a mute process with a characteristic corresponding to an electric field strength of the signal that is received; a volume control unit configured to control a volume level of the signal after the mute process to be constant when the volume level of the signal is within a predetermined range; and a low-input attenuation unit configured to receive an input signal of which the volume level has been controlled by the volume control unit and to attenuate the input signal when the volume level of the input signal is lower than a predetermined level. The radio receiver may further include a signal level measurement unit configured to measure a level of the signal that is received. The characteristic of the mute unit is set in a manner such that an attenuation amount is increased when the level of the signal measured by the signal level measurement unit is low.

In a case where volume is controlled to be constant, noise in a low-strength electric field, such as interchannel noise, can be reduced because the received signal is attenuated when the level thereof is low. Additionally, the S/N ratio of a normal-strength electric field can be improved because the input signal is attenuated when the volume level thereof after the volume control process has been performed is lower than the predetermined level.

The characteristic of the above-described mute unit is preferably set in a manner such that an attenuation amount thereof is determined so as to improve the S/N ratio which degrades due to volume control by the volume control unit when an electric field is weak. In addition, the characteristic of the mute unit is preferably set in consideration of an amount of change of the S/N ratio which degrades due to volume control by the volume control unit when an electric field is weak. In such a manner, improvement of the S/N ratio which degrades due to volume control when the electric field is weak can be ensured.

Further, a radio receiver described in the present application may preferably include a front-end section configured to convert a frequency of the signal that is received and to generate an intermediate frequency signal. In addition, the signal level measurement unit is preferably an S meter that is configured to measure a level of the intermediate frequency signal. In this case, the electric field strength around the radio receiver can be detected.

Further, in the above-described low-input attenuation unit, it is preferable that the attenuation amount is increased as the volume level of an input signal decreases below the predetermined level. In this case, when the volume level of a signal is low, noise in the output signal can be decreased.

In addition, in the above-described volume control unit, it is preferable that the volume level of an output signal is reduced as the volume level of the input signal decreases from the predetermined range. In this case, when the volume level of the input signal is smaller than the predetermined range, unnecessary volume control can be omitted.

In addition, the above-described mute unit preferably has a plurality of attenuation characteristics which are selected based on whether the volume control unit is enabled or disabled. In addition, in the mute unit, the attenuation amount is preferably larger when the volume control unit is enabled than when the volume control unit is disabled. Therefore, it is possible to avoid a noticeable change for users due to a difference between when the volume is controlled and not controlled.

In addition, the above-described radio receiver preferably receives an AM or FM broadcast signal. In such a case, interchannel noise can be reduced and the S/N ratio of a normal-strength electric field can be improved.

### BRIEF DESCRIPTION OF THE DRAWINGS

FIG. 1 illustrates one embodiment of a configuration of an AM/FM radio receiver.

FIG. 2 illustrates a characteristic of a mute circuit.

FIG. 3 illustrates a characteristic of a volume balance optimizing circuit.

FIG. 4 illustrates a characteristic of a low-input attenuation circuit.

FIG. 5 illustrates radio input/output characteristics, with a volume balance optimizing circuit enabled and disabled.

### DETAILED DESCRIPTION OF THE DRAWINGS

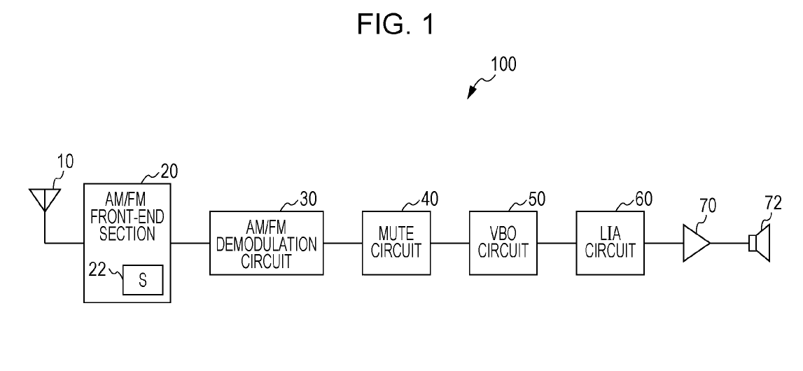

Hereinafter, an implementation of an AM/FM radio receiver will be described with reference to the drawings. FIG. 1 illustrates a configuration of an AM/FM radio receiver according to one embodiment. As illustrated in FIG. 1, an AM/FM radio receiver 100 includes an antenna 10, an AM/FM front-end section 20, an AM/FM demodulation circuit 30, a mute circuit 40, a volume balance optimizing circuit (VBO circuit) 50, a low-input attenuation circuit (LIA circuit) 60, an amplifier 70, and a speaker 72.

The AM/FM front-end section 20 extracts a signal (an RF signal) with a predetermined frequency (a tuning frequency) from signals received by the antenna 10. The frequency of the extracted signal is converted to obtain an intermediate frequency signal (an IF signal) which is then amplified. An S meter 22 in the AM/FM front-end section 20 AM demodulates the amplified intermediate frequency signal and measures the level of the intermediate frequency signal. The S meter 22 outputs the received electric field strength signal indicating the level of the intermediate frequency signal to the mute circuit 40 used in a later part of the process.

The intermediate frequency signal from the AM/FM front-end section 20 is AM or FM demodulated by the AM/FM demodulation circuit 30. The AM/FM demodulation circuit 30 outputs the resulting audio signal.

The demodulated signal output from the AM/FM demodulation circuit 30 is subjected to a mute process by the mute circuit 40 on the basis of the strength of the received electric field. A mute characteristic in the mute circuit 40 is set in a manner such that when the signal level measured by the S meter 22 is low, the attenuation amount is increased. Further, the attenuation amount is determined to improve the S/N ratio in consideration of the amount of change of the S/N ratio which degrades due to volume control by the volume balance optimizing circuit 50 when the electric field is weak.

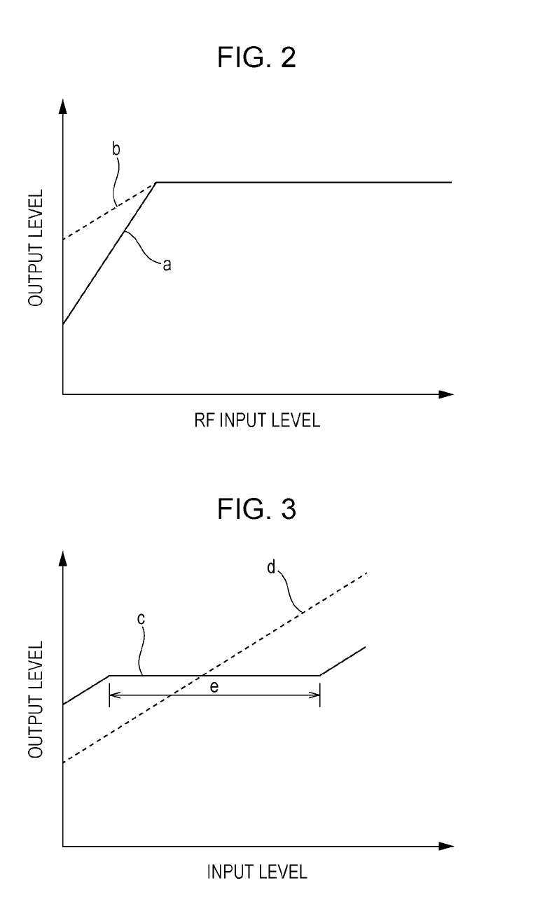

FIG. 2 illustrates a characteristic of the mute circuit 40. In FIG. 2, the horizontal axis represents RF input level (i.e., the level of the intermediate frequency signal measured by the S meter 22), and the vertical axis represents output level. In FIG. 2, “a” and “b” represent an attenuation characteristic (a mute characteristic) with the volume balance optimizing circuit 50 enabled and disabled, respectively. As illustrated in FIG. 2, the attenuation amount is larger when the volume balance optimizing circuit 50 is enabled than when the volume balance optimizing circuit 50 is disabled.

The volume balance optimizing circuit 50 is provided to perform a volume balance optimizing process. The volume balance optimizing circuit 50 controls the volume level of an audio signal after the mute process has been performed by the mute circuit 40 so that the output volume level is constant when the input level is within a predetermined range (a range “e” in FIG. 3). When the volume level of the input audio signal is lower than the predetermined range, the volume balance optimizing circuit 50 lowers the volume level of the output signal. Note that as the volume level of the input signal decreases, the volume level of the output signal is decreased.

FIG. 3 illustrates a characteristic of the volume balance optimizing circuit 50. In FIG. 3, the horizontal axis represents input level (i.e., volume level of an input audio signal), and the vertical axis represents output level (i.e., volume level of an output audio signal). In FIG. 3, “c” and “d” represent an output level with the volume balance optimizing circuit 50 enabled and disabled, respectively. As illustrated in FIG. 3, in the range “e”, the volume level of an output audio signal is constant. When an input level is lower than the range “e”, the volume level of the output audio signal is reduced rather than being kept constant.

The signal after volume control by the volume balance optimizing circuit 50 is input into the low-input attenuation circuit 60. The low-input attenuation circuit 60 attenuates the input signal when the volume level thereof is lower than the predetermined level (note that the predetermined level corresponds to an output level of the range “e” in FIG. 3). Specifically, as the volume level of the input signal decreases from the predetermined level, the attenuation amount increases. An audio signal output from the low-input attenuation circuit 60 is amplified by the amplifier 70 and output by the speaker 72.

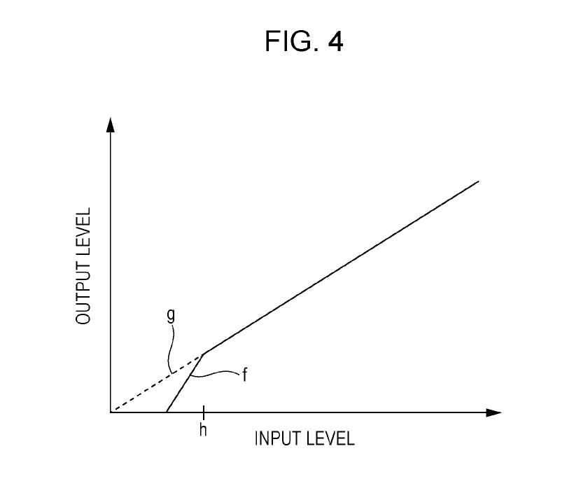

FIG. 4 illustrates a characteristic of the low-input attenuation circuit 60. In FIG. 4, the horizontal axis represents input level (of a signal of which volume level has been controlled by the volume balance optimizing circuit 50), and the vertical axis represents output level (i.e., volume level of an output audio signal). In FIG. 4, “f” and “g” represent an output level with the low-input attenuation circuit 60 enabled and disabled, respectively. As illustrated in FIG. 4, when an input level is equal to or higher than “h”, the output level is equal to the input level, while as the input level decreases from “h”, the signal level is more attenuated.

The above-described AM/FM demodulation circuit 30, the mute circuit 40, the volume balance optimizing circuit 50, the low-input attenuation circuit 60, and the S meter 22 correspond to a demodulation unit, a mute unit, a volume control unit, a low-input attenuation unit, and a signal level measurement unit, respectively.

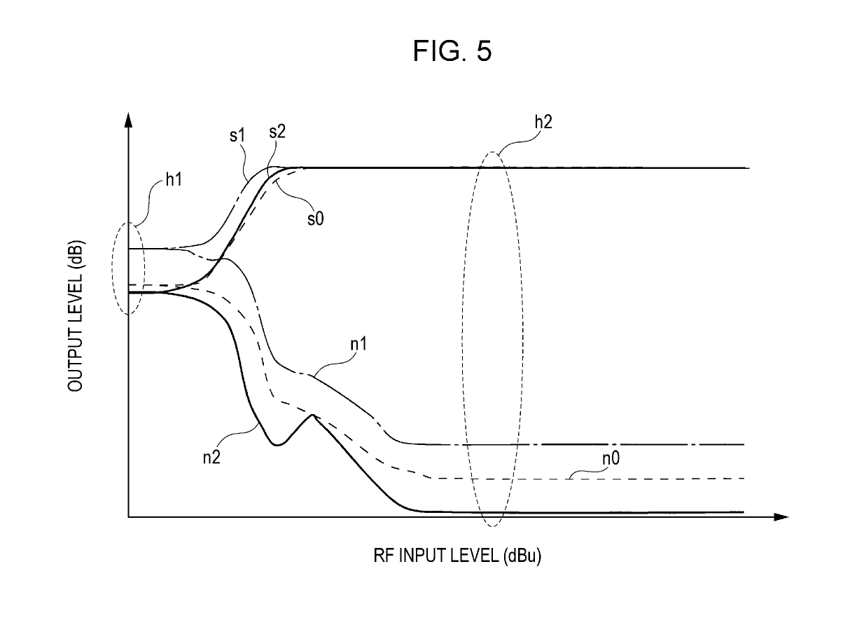

FIG. 5 illustrates radio input/output characteristics, with the volume balance optimizing circuit 50 enabled and disabled, respectively. In FIG. 5, the horizontal axis represents RF input level, and the vertical axis represents output level of an audio signal. In FIG. 5, “s0” and “n0” represent a signal component and a noise component, respectively in a case where the volume balance optimizing circuit 50 is disabled, the low-input attenuation circuit 60 is disabled, and a characteristic of the mute circuit 40 is “b” (see, FIG. 2). In addition, “s1” and “n1” represent a signal component and a noise component, respectively in a case where the volume balance optimizing circuit 50 is enabled, the low-input attenuation circuit 60 is disabled, and a characteristic of the mute circuit 40 is “b” (see, FIG. 2).

In addition, “s2” and “n2” represent a signal component and a noise component, respectively in a case where the volume balance optimizing circuit 50 is enabled, the low-input attenuation circuit 60 is enabled, and a characteristic of the mute circuit 40 is “a” (see, FIG. 2).

As illustrated in FIG. 5, in a conventional configuration, the use of the volume balance optimizing circuit 50 leads to an increase in interchannel noise (see area “h1” in FIG. 5) and a reduction in an S/N ratio of a normal-strength electric field (see area “h2” in FIG. 5).

On the other hand, in implementations of the present invention, interchannel noise can be improved to the same or a higher level of interchannel noise in a conventional structure with the volume balance optimizing circuit 50 disabled. In addition, the S/N ratio of a normal-strength electric field can have a better value than the S/N ratio in the conventional structure with the volume balance optimizing circuit 50 disabled.

As described above, the AM/FM radio receiver 100 according to this embodiment can reduce noise in a low-strength electric field such as interchannel noise, even when the volume level is controlled to be constant by the volume balance optimizing circuit 50, because a mute process by the mute circuit 40 is employed in which a signal is attenuated when the level of a received signal is low. Further, a process by the low-input attenuation circuit 60 is also employed in which a signal of which the volume level has been controlled by the volume balance optimizing circuit 50 is attenuated when the volume level thereof is lower than the predetermined level; therefore, the S/N ratio of a normal-strength electric field can be improved.

With regard to a mute characteristic of the mute circuit 40, an attenuation amount is determined so as to improve a S/N ratio which degrades due to volume control by the volume balance optimizing circuit 50 when an electric field is weak. In addition, the characteristic of the mute unit is set in consideration of the amount of change of a S/N ratio which degrades due to volume control by the volume balance optimizing circuit 50 when an electric field is weak. Therefore, improvement of a S/N ratio which degrades due to volume control when the electric field is weak can be ensured.

In addition, in the low-input attenuation circuit 60, as volume of an input signal decreases below a predetermined level, the attenuation amount is increased. Therefore, when the volume level of an input signal is low, noise in the output signal can be decreased.

In addition, in the volume balance optimizing circuit 50, when the volume level of an input signal is lower than a predetermined range, as the volume level decreases, the volume level of the output signal is lowered. Therefore, unnecessary volume control can be omitted when the input volume is lower than the predetermined range.

Further, the mute circuit 40 has a plurality of attenuation characteristics which are selected in consideration of whether the volume balance optimizing circuit 50 is enabled or disabled. Specifically, an attenuation characteristic is set in a manner such that the attenuation amount is larger when the volume balance optimizing circuit 50 is enabled than when the volume balance optimizing circuit 50 is disabled. Therefore, it is possible to avoid a noticeable change for users due to a difference between when volume is controlled and not controlled.

Note that the present invention is not limited to the above embodiment and various modifications can be made within the scope of the present invention. For example, although the AM/FM radio receiver 100 in the embodiment can receive both AM and FM broadcasts, only one of AM or FM broadcasts may be received. In addition, the radio receiver may be made into a standalone product or may be incorporated into a smartphone or the like.

Further, the AM/FM demodulation circuit 30, the mute circuit 40, and other components in the embodiment may be partially realized by digital processing by, for example, a digital signal processor (DSP).

As described above, in implementations of the present invention, in a case where the volume level is controlled to be constant, noise in a low-strength electric field such as interchannel noise can be reduced because a received signal is attenuated when the level thereof is low, and the S/N ratio of a normal-strength electric field can be improved because an input signal is attenuated when the volume level thereof after volume control is performed is lower than a predetermined level.

It is intended that the foregoing detailed description be regarded as illustrative rather than limiting, and that it be understood that it is the following claims, including all equivalents, that are intended to define the spirit and scope of this invention.

What is claimed is:

1. A radio receiver comprising:
a demodulation unit configured to demodulate a signal that is received;
a mute unit that is configured to perform, on the signal demodulated by the demodulation unit, a mute process with a characteristic corresponding to an electric field strength of the signal that is received;
a volume control unit configured to control a volume level of the signal after the mute process to be constant when the volume level of the signal is within a predetermined range; and
a low-input attenuation unit configured to receive an input signal of which the volume level has been controlled by the volume control unit and to attenuate the input signal when the volume level of the input signal is lower than a predetermined level.

2. The radio receiver according to claim 1, further comprising:
a signal level measurement unit configured to measure a level of the signal that is received,
wherein the characteristic of the mute unit is set in a manner such that an attenuation amount is increased when the level of the signal measured by the signal level measurement unit is low.

3. The radio receiver according to claim 2, wherein the characteristic of the mute unit is set in a manner such that the attenuation amount is determined so as to improve a S/N ratio that degrades due to volume control by the volume control unit when an electric field is weak.

4. The radio receiver according to claim 1, wherein the characteristic of the mute unit is set in consideration of an amount of change of a S/N ratio that degrades due to volume control by the volume control unit when an electric field is weak.

5. The radio receiver according to claim 2, further comprising:
a front-end section configured to convert a frequency of the signal that is received and to generate an intermediate frequency signal,
wherein the signal level measurement unit is an S meter that measures a level of the intermediate frequency signal.

6. The radio receiver according to claim 1, wherein the attenuation amount is increased in the low-input attenuation unit as the volume level of the input signal decreases below the predetermined level.

7. The radio receiver according to claim 1, wherein a volume level of an output signal is reduced in the volume control unit as the volume level of the input signal decreases from the predetermined range.

8. The radio receiver according to claim 1, wherein the mute unit has a plurality of attenuation characteristics that are selected based on whether the volume control unit is enabled or disabled.

9. The radio receiver according to claim 8, wherein in the mute unit, the attenuation amount is larger when the volume control unit is enabled than when the volume control unit is disabled.

10. The radio receiver according to claim 9, wherein the radio receiver is configured to receive an AM broadcast signal or an FM broadcast signal.
